(19) United States
(12) Patent Application Publication
(10) Pub. No.: US 2026/0106101 A1
(43) Pub. Date: Apr. 16, 2026

(54) RELAY

(71) Applicant: XIAMEN HONGFA SIGNAL ELECTRONICS CO., LTD., Xiamen (CN)

(72) Inventors: Jiabin LIN, Xiamen (CN); Zhugu LI, Xiamen (CN); Yongbin HUANG, Xiamen (CN)

(21) Appl. No.: 19/116,316

(22) PCT Filed: Sep. 21, 2023
(86) PCT No.: PCT/CN2023/120489

§ 371 Date: Mar. 27, 2025

(30) Foreign Application Priority Data
Sep. 30, 2022 (CN) 202211210067.9

(51) Int. Cl. H01H 51/22; H01H 50/04; H01H 50/28; H01H 50/54

(52) U.S. Cl. CPC H01H 51/2272; H01H 50/043; H01H 50/28; H01H 50/548; H01H 2225/014

(57) ABSTRACT

A relay with high action reliability includes a base part and a movable part that is swingable relative to the base part. The movable part includes a movable contact piece, an armature, and a first plastic body, and the movable contact piece and the armature are assembled into an integral piece through the first plastic body. The movable contact piece includes a movable contact body and a soldering lug structure. The soldering lug structure includes a connecting portion and a soldering portion, and the soldering portion is connected to the movable contact body through the connecting portion. The soldering portion includes a first soldering structure and a second soldering structure that are soldered to the base part; and the first soldering structure and the second soldering structure are at a same side of the connecting portion in a length direction of the armature.

### CROSS-REFERENCE

The present disclosure is a national stage of International PCT Application No. PCT/CN2023/120489, filed on Sep. 21, 2023, which claims priority to Chinese Patent Application No. 202211210067.9, filed on Sep. 30, 2022 and titled “Relay with High Action reliability”, the entire content of which is incorporated herein by reference in its entirety.

### TECHNICAL FIELD

The present disclosure relates to the technical field of electrical control devices and, more particularly, to a relay with high action reliability.

### BACKGROUND

Ultra-small electromagnetic relays are widely used in fields such as network communication, medical equipment, test equipment, and security due to advantages of small size, low coil power consumption, dual pole double throw contact output capability, and good reliability. The ultra-small electromagnetic relay in the related art usually consists of a movable contact piece and armature part, a base part, and a housing. The movable contact piece and armature part is formed by combining an armature, a permanent magnet, and a movable spring portion containing a movable contact as a whole through injection molding. The movable spring portion is usually symmetrically distributed with the armature as a center. The base part is usually formed by combining a coil portion and a static spring portion with a static contact through injection molding. The movable contact piece and armature part is supported and positioned at an approximately center position with the base in a vertical direction, and is fixed as a whole by soldering the movable spring and the static spring on the base part. Then, an electromagnetic relay is formed after the housing is mounted. When the relay coil is energized and deenergized, the movable contact piece and armature part forms a pivot point with a support part of the base, so that the armature during a swinging process drives the movable spring to swing back and forth, causing a circuit of the spring piece portion to be connected and disconnected. Due to a fixed connection between the movable spring and the base part through soldering, the movable spring portion between the pivot point and a solder joint of the movable contact piece and armature part will deform, generating a reaction force. The reaction force cooperates with a magnetic attraction force generated by the coil after being energized, so that an operating voltage and a release voltage of the relay meet requirements and parameters are stable. In the above application fields, relays usually require frequent switching, and in some working scenarios, products are required to work reliably for more than 100 million times, so the movable contact piece and armature part as the operating component is required to have good fatigue resistance and reliable parameter stability, so as to meet the requirements of ultra-high service life and consistency.

However, the solder joint between the movable spring and the base part in the related art are prone to stress fatigue and a risk of disengagement failure, resulting in permanent failure of the relay.

### SUMMARY

The relay with high action reliability according to embodiments of the present disclosure includes a base part and a movable part that is swingable relative to the base part. The movable part includes a movable contact piece, an armature, and a first plastic body, and the movable contact piece and the armature are assembled into an integral piece through the first plastic body. The movable contact piece includes a movable contact body and a soldering lug structure. The soldering lug structure includes a connecting portion and a soldering portion, and the soldering portion is connected to the movable contact body through the connecting portion. The soldering portion includes a first soldering structure and a second soldering structure that are soldered to the base part; and the first soldering structure and the second soldering structure are at a same side of the connecting portion in a length direction of the armature.

In some embodiments of the present disclosure, the soldering portion is not coplanar with the movable contact body.

In some embodiments of the present disclosure, the connecting portion is coplanar with the movable contact body; a fold line is provided at a connection between the connecting portion and the soldering portion, and the soldering portion is bent relative to the connecting portion through the fold line.

In some embodiments of the present disclosure, a portion of the soldering portion provided with the first soldering structure and the second soldering structure is bent relative to the movable contact body towards a direction away from the base part; or the portion of the soldering portion provided with the first soldering structure and the second soldering structure is bent relative to the movable contact body towards a direction close to the base part. In some embodiments of the present disclosure, an extension direction of the fold line is perpendicular to the length direction of the armature.

In some embodiments of the present disclosure, along the length direction of the armature, the fold line is at another side of the connecting portion relative to the first soldering structure and the second soldering structure.

In some embodiments of the present disclosure, two ends of the movable contact body in the length direction of the armature are provided with a normally open movable contact and a normally closed movable contact, respectively; and a connection line between the normally open movable contact and the normally closed movable contact passes through a midpoint of the fold line.

In some embodiments of the present disclosure, the soldering portion includes: a body portion connected to the movable contact body through the connecting portion, the first soldering structure and the second soldering structure being on the body portion; and a widened part connected to the body portion and corresponding to a position of the first soldering structure and/or the second soldering structure along a width direction of the armature.

In some embodiments of the present disclosure, along the length direction of the armature, the first soldering structure is closer to the connecting portion relative to the second soldering structure; the widened part includes a first widened section and a second widened section, the first widened section corresponding to a position of the first soldering structure, and the second widened section corresponding to a position of the second soldering structure; along the width direction of the armature, a size of the first widened section is smaller than a size of the second widened section.

In some embodiments of the present disclosure, along the length direction of the armature, the first soldering structure is closer to the connecting portion relative to the second soldering structure; the widened part includes a first widened section and a second widened section, the first widened section corresponding to a position of the first soldering structure, and the second widened section corresponding to a position of the second soldering structure; the first widened section completely covers the position of the first soldering structure in the length direction of the armature, and the second widened section completely covers the position of the second soldering structure in the length direction of the armature.

In some embodiments of the present disclosure, along the length direction of the armature, a start point of the first widened section is closer to the connecting portion relative to the first soldering structure.

In some embodiments of the present disclosure, the first soldering structure and the second soldering structure are at a side of the soldering portion facing away from the movable contact body, and the widened part is at a side of the soldering portion facing the movable contact body.

In some embodiments of the present disclosure, two ends of the movable contact body in the length direction of the armature are provided with a normally open movable contact and a normally closed movable contact, respectively; and a plane where the normally open movable contact and the normally closed movable contact are located is coplanar with a pole surface of the armature or is higher than pole surface of the armature.

In some embodiments of the present disclosure, a side of the movable contact body facing the soldering lug structure is provided with a recess, and the recess is disposed at an edge of a connection between the connecting portion and the movable contact body.

In some embodiments of the present disclosure, the soldering portion is coplanar with the movable contact body.

In some embodiments of the present disclosure, the soldering portion includes: a bent section, one end of the bent section being connected to the connecting portion; and an extension section, one end of the extension section being connected to another end of the bent section, and the first soldering structure and the second soldering structure being in the extension section. A width of a portion of the bent section connected to the connecting portion is less than or equal to a width of a portion of the extension section provided with the first soldering structure and the second soldering structure.

In some embodiments of the present disclosure, the connecting portion includes: a first connecting section, one end of the first connecting section being connected to the movable contact body, and a width of the first connecting section being greater than a width of the bent section; and a second connecting section, one end of the second connecting section being connected to another end of the first connecting section, another end of the second connecting section being connected to the bent section, and the first connecting section being perpendicular to the second connecting section.

### BRIEF DESCRIPTION OF THE DRAWINGS

FIG. 1 shows a schematic perspective view of a relay according to a first embodiment of the present disclosure.

FIG. 2 shows a schematic perspective view of FIG. 1 with a housing removed.

FIG. 3 shows a schematic side view of FIG. 1 with the housing removed.

FIG. 4 shows a schematic view of FIG. 2 with a second plastic body removed.

FIG. 5 shows a schematic view of FIG. 3 with the second plastic body removed.

FIG. 6 shows a schematic view of a base part.

FIG. 7 shows a schematic view of a coil and an iron core.

FIG. 8 shows a schematic view of a static contact unit and a coil terminal.

FIGS. 9-11 show schematic views of a movable part according to the first embodiment of the present disclosure from three different angles of view.

FIG. 12A shows a schematic perspective view of one movable contact piece in the first embodiment of the present disclosure.

FIG. 12B shows a schematic perspective view of another movable contact piece in the first embodiment of the present disclosure.

FIG. 13 shows a schematic side view of FIG. 12B.

FIG. 14A shows a schematic top view of FIG. 12A.

FIG. 14B shows a schematic top view of FIG. 12B.

FIG. 15 shows an enlarged partial view of X1 in FIG. 13.

FIG. 16 shows an enlarged partial view of X2 in FIG. 14B.

FIG. 17 shows a schematic side view of a relay according to a second embodiment of the present disclosure with a housing removed.

FIG. 18 shows a schematic side view of a movable contact piece in FIG. 17.

FIG. 19 shows an enlarged partial view of X3 in FIG. 18.

FIGS. 20 and 21 show schematic views of a movable part of a relay according to a third embodiment of the present disclosure from two different angles of view.

FIG. 22A shows a schematic perspective view of one movable contact piece of the relay according to the third embodiment of the present disclosure.

FIG. 22B shows a schematic perspective view of another movable contact piece of the relay according to the third embodiment of the present disclosure.

FIG. 23A shows a schematic view of one movable contact piece of a relay according to a fourth embodiment of the present disclosure.

FIG. 23B shows a schematic view of another movable contact piece of the relay according to the fourth embodiment of the present disclosure.

FIG. 24 shows a schematic view of a magnitude of a reaction force generated by deformation of a soldering lug structure according to embodiments of the present disclosure.

### REFERENCE NUMERALS

1. Housing; 2. Movable part; 21. Armature; 22. Movable contact piece; 221. Movable contact body; 2211. Normally open movable contact; 2212. Normally closed movable contact; 2213. Recess; 222. Soldering lug structure; 223. Connecting portion; 2231. First connecting section; 2232. Second connecting section; 224. Soldering portion; 225. body portion; 2251. Bent section; 2252. Extension section; 226. Widened section; 2261. First widened section; 2262. Second widened section; 227. Fold line; 228. First soldering structure; 229. Second soldering structure; 23. First plastic body; 24. Permanent magnet; 25. First positioning portion; 3. Base part; 31. Coil; 32. Iron core; 33. Static contact unit; 331. Normally open static contact piece; 3311. Normally open static contact lead-out terminal; 3312. Normally open static contact; 332. Normally closed static contact piece; 3321. Normally closed static contact lead-out terminal; 3322. Normally closed static contact; 333. Common end contact piece; 3331. Common end lead-out terminal; 3332. Soldering table; 34. Coil terminal; 341. Lead-out terminal; 35. Second plastic body; 351. Positioning groove; 36. Second positioning portion; D1. Length direction; D2. Width direction.

### DETAILED DESCRIPTION

Exemplary embodiments will now be described more comprehensively with reference to the accompanying drawings. However, the exemplary embodiments may be implemented in various forms and should not be construed as being limited to the implementations set forth herein. Instead, these embodiments are provided so that the present disclosure will be thorough and complete, and concepts of the exemplary embodiments will be fully given to those skilled in the art. Same reference numbers denote the same or similar structures in the drawings, and thus the detailed description thereof will be omitted.

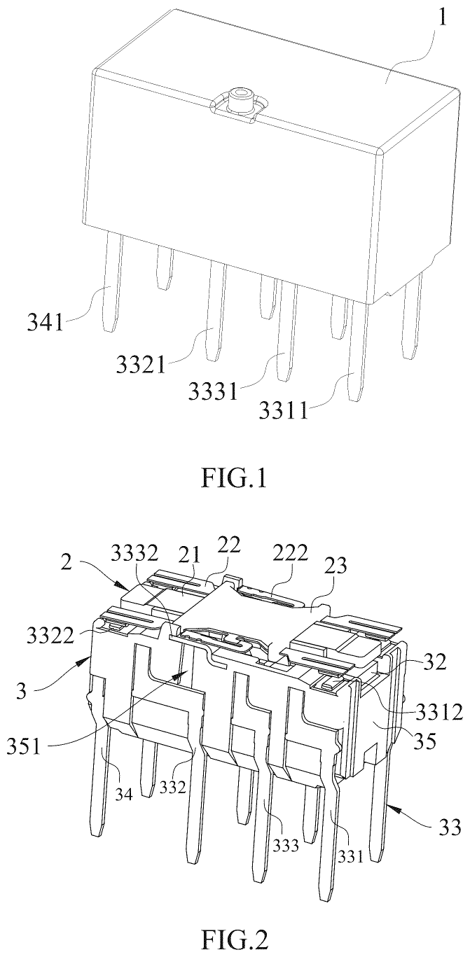

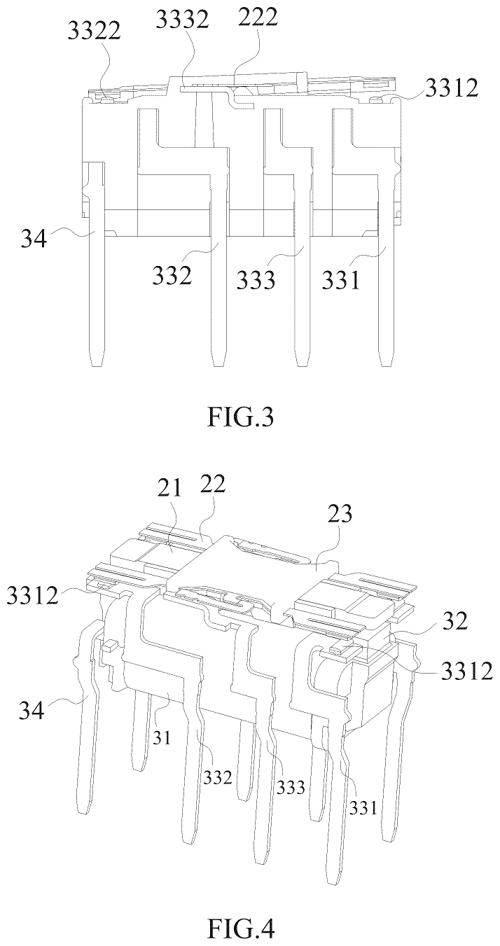

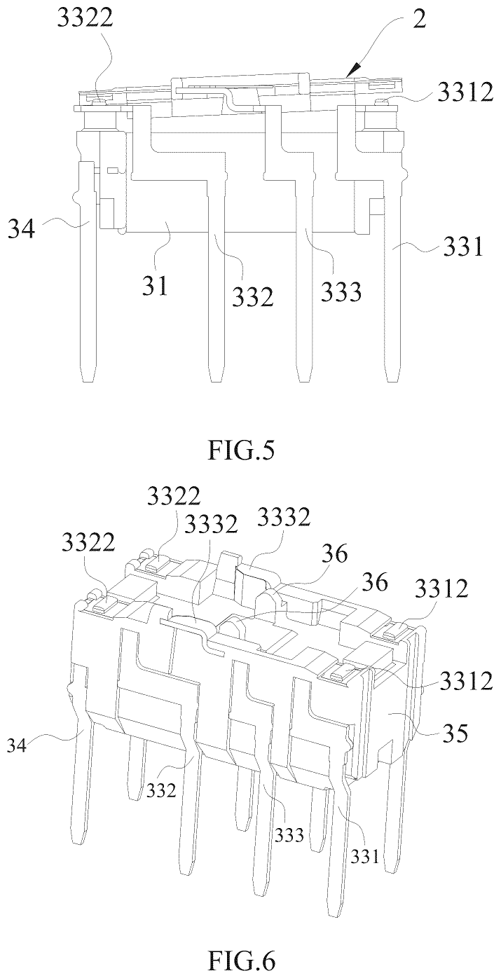

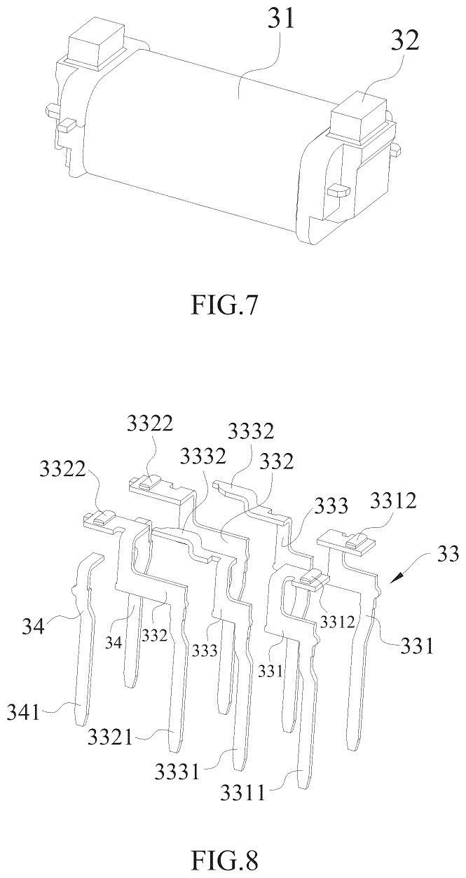

As shown in FIGS. 1 to 8, FIG. 1 shows a schematic perspective view of a relay according to a first embodiment of the present disclosure; FIG. 2 shows a schematic perspective view of FIG. 1 with a housing 1 removed; FIG. 3 shows a schematic side view of FIG. 1 with the housing 1 removed; FIG. 4 shows a schematic view of FIG. 2 with a second plastic body 35 removed; FIG. 5 shows a schematic view of FIG. 3 with the second plastic body 35 removed; FIG. 6 shows a schematic view of a base part 3; FIG. 7 shows a schematic view of a coil and an iron core 32; FIG. 8 shows a schematic view of a static contact unit 33 and a coil terminal 34.

The relay according to embodiments of the present disclosure includes a housing 1, a movable part 2, and a base part 3. The movable part 2 is arranged above the base part 3, and the movable part 2 may swing relative to the base part 3. The housing 1 covers the movable part 2 and the base part 3.

It can be understood that terms “including” and “having” as well as any variations thereof in embodiments of the present disclosure are intended to cover non-exclusive inclusions. For example, a process, method, system, product, or device that includes a series of steps or units is not limited to the listed steps or units, but may optionally include steps or units that are not listed, or may optionally include other steps or components inherent to these processes, methods, products, or devices.

The base part 3 includes a coil 31, an iron core 32, a static contact unit 33, a coil terminal 34, and a second plastic body 35. The second plastic body 35 assembles the coil 31, the iron core 32, the static contact unit 33, and the coil terminal 34 into an integral piece by injection molding.

The coil 31 may include a coil bobbin and an enameled wire, with the enameled wire wound around an outer circumference of the coil bobbin. The static contact unit 33 includes two normally open static contact pieces 331, two normally closed static contact pieces 332, and two Common end contact pieces 333.

A first end of the normally open static contact piece 331 is provided with a normally open static contact lead-out terminal 3311 that exposes a side surface of the second plastic body 35; a first end of the normally closed static contact piece 332 is provided with a normally closed static contact lead-out terminal 3321 that exposes the side surface of the second plastic body 35; and a first end of the Common end contact piece 333 is provided with a common end lead-out terminal 3331 that exposes the side surface of the second plastic body 35.

A second end of the normally open static contact piece 331 is provided with a normally open static contact 3312 that exposes a top surface of the second plastic body 35; a second end of the normally closed static contact piece 332 is provided with a normally closed static contact 3322 that exposes the top surface of the second plastic body 35; and a second end of the Common end contact piece 333 is provided with a soldering table 3332 that exposes the top surface of the second plastic body 35.

In the base part 3, a lead-out terminal 341 of the coil terminal 34 is at one end of the second plastic body 35. The normally closed static contact lead-out terminal 3321, the common end lead-out terminal 3331, and the normally open static contact lead-out terminal 3311 are arranged in sequence from one end of the second plastic body 35 to the other end of the second plastic body 35. The normally open static contact lead-out terminal 3311 is at the other end of the second plastic body 35.

As shown in FIG. 2, the side surface of the second plastic body 35 is provided with a positioning groove 351 whose position corresponds to a position of the soldering table 3332. The positioning groove 351 is used to accommodate an insert during the injection molding process, so that the insert may position the soldering table 3332 and ensure consistency of parameters of the relay.

Specifically, when the coil 31, the iron core 32, the static contact unit 33, the coil terminal 34, and the second plastic body 35 are assembled into an integral piece by injection molding, the insert is disposed in an injection mold and in the positioning groove 351 of the second plastic body 35, to achieve a function of positioning the soldering table 3332.

As an example, the positioning groove 351 may have a trapezoidal shape and be “small at the top and large at the bottom”. On the one hand, the trapezoidal shape of the positioning groove 351 facilitates demolding; on the other hand, the larger size at the lower portion of the positioning groove 351 helps to reinforce strength of the insert.

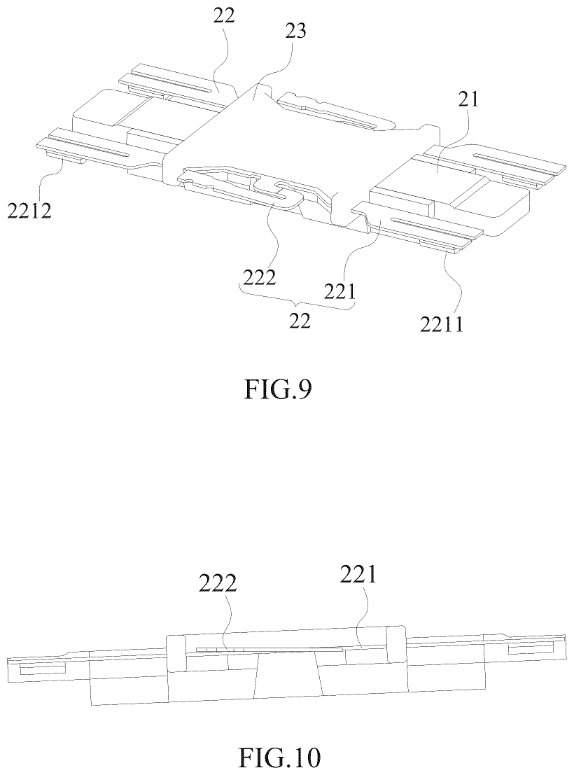

As shown in FIGS. 9 to 11, FIGS. 9 to 11 show schematic views of the movable part 2 according to the first embodiment of the present disclosure from three different angles of view. The movable part 2 includes two movable contact pieces 22, an armature 21, a permanent magnet 24, and a first plastic body 23. The first plastic body 23 assembles the two movable contact pieces 22, the armature 21, and the permanent magnet 24 into an integral piece through injection molding. The permanent magnet 24 may be disposed at a side of the armature 21 facing the base part 3. The two movable contact pieces 22 are respectively disposed at two opposite sides of the armature 21 in a width direction D2. The two movable contact pieces 22 may be symmetrically arranged with the armature 21 as a center.

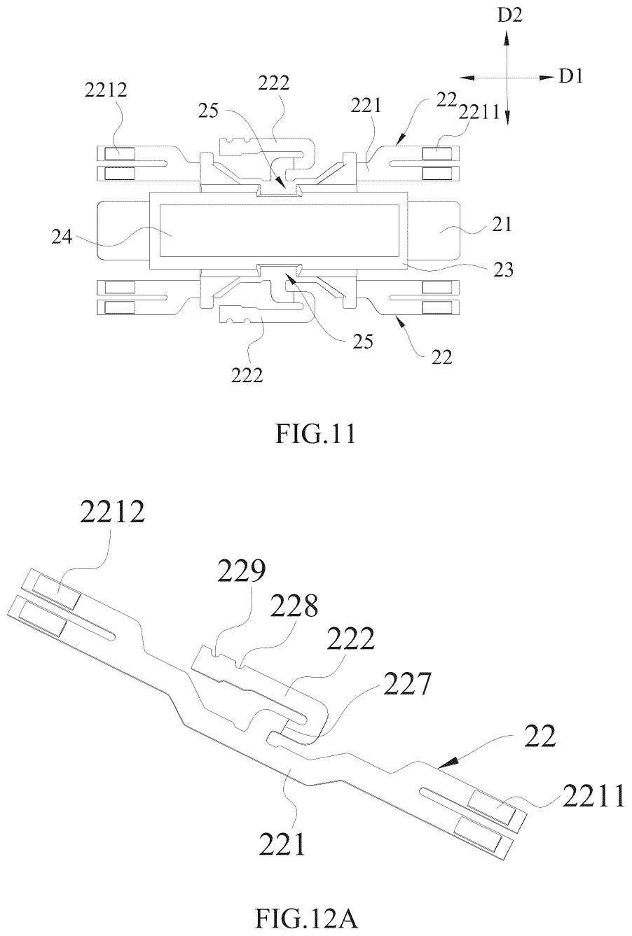

As shown in FIGS. 6 and 11, the movable part 2 also includes a first positioning portion 25, and the base part 3 also includes a second positioning portion 36. The first positioning portion 25 and the second positioning portion 36 are positioned and coordinated. That is, the first positioning portion 25 and the second positioning portion 36 form a swinging fulcrum, allowing the movable part 2 to swing relative to the base part 3 at this fulcrum.

As an example, the movable part 2 includes two first positioning portions 25, and the base part 3 includes two second positioning portions 36. The two first positioning portions 25 are spaced apart along the movable part 2 in the width direction D2 and located at a middle position of the movable part 2 in a length direction D1. The two second positioning portions 36 are spaced apart along the base part 3 in the width direction D2 and located at a middle position of the base part 3 in the length direction D1.

As an example, the first positioning portion 25 may be a positioning groove disposed at a side of the movable part 2 facing the base part 3. The second positioning portion 36 may be a positioning protrusion disposed on a surface of the base part 3 facing the movable part 2, and the positioning protrusion may extend into the positioning groove to achieve positioning.

Certainly, in other embodiments, the first positioning portion 25 may also be a positioning protrusion, while the second positioning portion 36 may be a positioning groove.

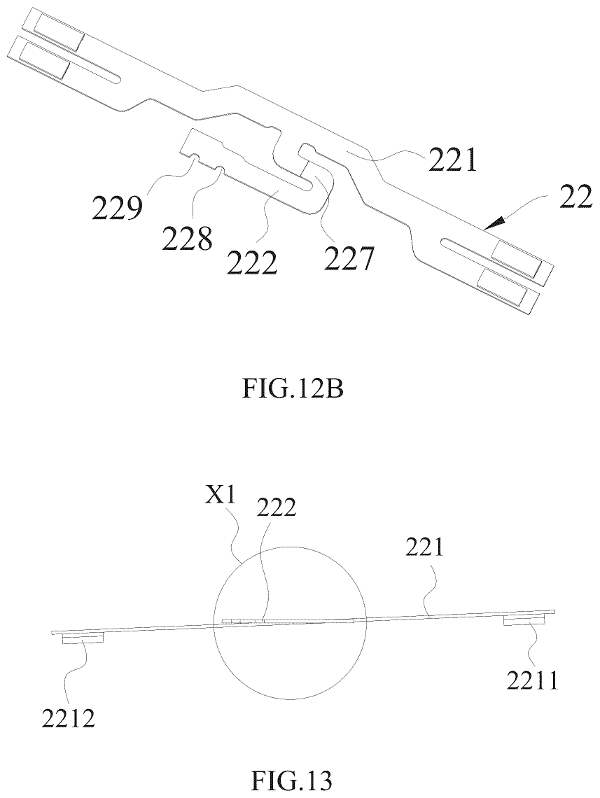

As shown in FIGS. 12A to 14B, the movable contact piece 22 includes a movable contact body 221 and a soldering lug structure 222, with the soldering lug structure 222 connected to the movable contact body 221. The soldering lug structure 222 is soldered to the soldering table 3332 of the base part 3, so that the movable part 2 forms a seesaw structure.

As an example, the movable contact body 221 has a long strip-like structure, and the soldering lug structure 222 is connected to a middle position of the movable contact body 221 in the length direction D1.

Two ends of the movable contact body 221 in the length direction D1 are provided with a normally open movable contact 2211 and a normally closed movable contact 2212, respectively. The normally open movable contact 2211 corresponds to the normally open static contact 3312 of the base part 3, and the normally closed movable contact 2212 corresponds to the normally closed static contact 3322 of the base part 3.

Still referring to FIGS. 12A to 14B, the soldering lug structure 222 includes a connecting portion 223 and a soldering portion 224. The soldering portion 224 is connected to the movable contact body 221 through the connecting portion 223. The soldering portion 224 includes a first soldering structure 228 and a second soldering structure 229 that are soldered to the base part 3. The first soldering structure 228 and the second soldering structure 229 are located at a same side of the connecting portion 223 along the length direction D1 of the armature 21.

In this embodiment, the movable contact piece 22 is connected to the base part 3 through the first soldering structure 228 and the second soldering structure 229. At least two soldering structures may better ensure the strength of connection between the movable contact piece 22 and the base part 3, making it difficult for the soldering lug structure 222 to detach from the base part 3 and improving the mechanical life of the relay. Meanwhile, the movable contact piece 22 is connected to the base part 3 through the first soldering structure 228 and the second soldering structure 229, which may better ensure conductivity and heat dissipation, thereby reducing a temperature rise at a solder joint position.

It can be understood that the first soldering structure 228 and the second soldering structure 229 are soldered to the soldering table 3332 of the Common end contact piece 333, for example, using laser soldering, but not limited thereto.

As an example, a line connecting the first soldering structure 228 and the second soldering structure 229 is approximately parallel to the length direction D1 of the armature 21. In other words, when the first soldering structure 228 and the second soldering structure 229 are soldered to the soldering table 3332 of the base part 3, two solder joints formed are linearly arranged along the length direction D1 of the armature 21.

It can be understood that the first soldering structure 228 and/or the second soldering structure 229 may be groove structures.

As an example, the first soldering structure 228 and the second soldering structure 229 are both groove structures, and the first soldering structure 228 and the second soldering structure 229 are both located at a side of the soldering portion 224 facing away from the movable contact body 221.

A groove wall of the groove structure may be curved to increase a length of a contour line of the combination of the soldering lug structure 222 and the soldering table 3332 after laser irradiation, thereby improving the bonding force of the solder joint and enhancing the mechanical life of the relay.

It can be understood that the specific structures of the first soldering structure 228 and the second soldering structure 229 may be the same or different. For example, one of the first soldering structure 228 and the second soldering structure 229 may be a groove structure, while the other may be another structure that can realize soldering. When both the first soldering structure 228 and the second soldering structure 229 are groove structures, the two groove structures may be the same or different dimensions.

As shown in FIG. 12A, FIG. 12B, and FIG. 15, FIG. 15 shows a partial enlarged view of X1 in FIG. 13. The soldering portion 224 is not coplanar with the movable contact body 221.

As an example, the connecting portion 223 is coplanar with the movable contact body 221. A fold line 227 is provided at the connection between the connecting portion 223 and the soldering portion 224, and an extension direction of the fold line 227 is perpendicular to the length direction D1 of the armature 21. The soldering portion 224 is bent relative to the connecting portion 223 through the fold line 227. In this way, during a swinging process of the movable part 2 relative to the base part 3, a position of deformation of the soldering lug structure 222 is around the fold line 227, thereby reducing transfer of deformation stress to the solder joint.

As shown in FIG. 15, a portion of the soldering portion 224 provided with the first soldering structure 228 and the second soldering structure 229 is bent relative to the movable contact body 221 in a direction away from the base part 3. That is, the soldering portion 224 is bent upwards relative to the movable contact body 221 and the connecting portion 223 through the fold line 227.

As shown in FIGS. 3 and 15, an angle β is formed between the soldering portion 224 and the movable contact body 221. When the first soldering structure 228 and the second soldering structure 229 of the soldering portion 224 are horizontally soldered on the soldering table 3332, the movable contact body 221 is lower on the left and higher on the right. Therefore, when the portion of the soldering portion 224 provided with the first soldering structure 228 and the second soldering structure 229 is bent in the direction away from the base part 3 relative to the movable contact body 221, the armature 21 at a side close to the coil terminal 34 contacts a pole surface of the iron core 32, forming a normally closed end; the armature 21 at a side away from the coil terminal 34 separates from the pole surface of the iron core 32, forming a normally open end.

It can be understood that the angle ß between the soldering portion 224 and the movable contact body 221 may be adjusted according to magnitude of an attraction force of the coil of the relay, thereby further improving the manufacturing qualification rate of products, enhancing the parameter stability and margin of products.

Along the length direction D1 of the armature 21, the fold line 227 is at another side of the connecting portion 223 relative to the first soldering structure 228 and the second soldering structure 229. In other words, along the length direction D1 of the armature 21, the first soldering structure 228 and the second soldering structure 229 are located at one side of the connecting portion 223, while the fold line 227 is located at the other side of the connecting portion 223.

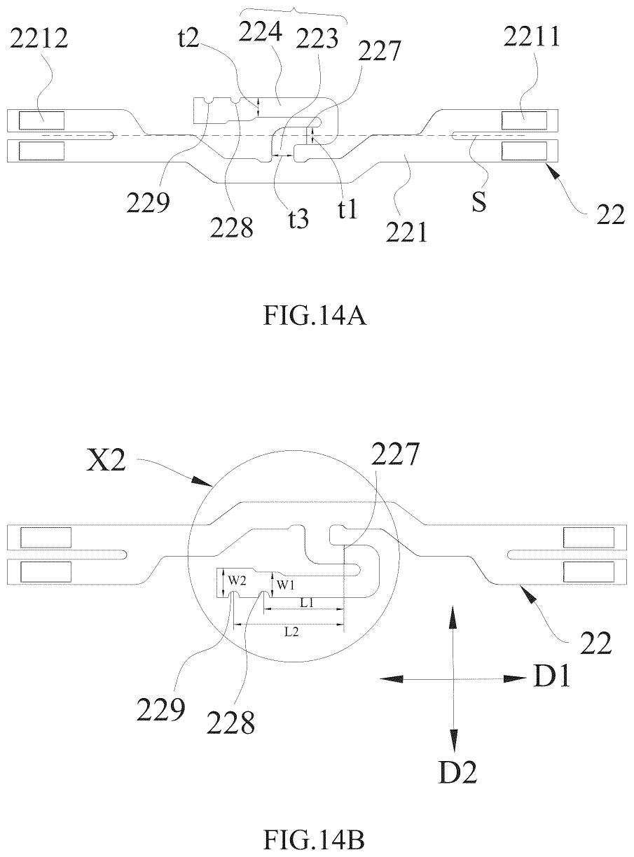

Still referring to FIGS. 14A and 14B, a connection line S between the normally open movable contact 2211 and the normally closed movable contact 2212 of the movable contact body 221 passes through a midpoint of the fold line 227. Through this design, when the movable part 2 swings relative to the base part 3, and the movable contact of the movable contact piece 22 comes into contact with the static contact of the static contact unit 33, a reaction force of the movable contact piece 22 that generates deformation is roughly collinear with the fold line 227, thereby reducing a lateral torque of the movable contact piece 22, improving the stability of the swinging action of the movable part 2, prolonging the mechanical life, and enhancing the consistency and stability of product parameters.

It should be noted that two ends of the connection line S start from a center point of the normally open movable contact 2211 and a center point of the normally closed movable contact 2212, respectively. For example, if each of the normally open movable contact 2211 and the normally closed movable contact 2212 is one contact, the two ends of the connection line S start from center points of respective contacts. If each of the normally open movable contact 2211 and the normally closed movable contact 2212 includes two contacts arranged side by side, one end of the connection line S starts from a center point of the two contacts of the normally open movable contact 2211, and the other end of the connection line S starts from a center point of the two contacts of the normally closed movable contact 2212.

As shown in FIG. 9, a plane where the normally open movable contact 2211 and the normally closed movable contact 2212 of the movable contact body 221 are located is higher than a pole surface of the armature 21, but this height difference is usually controlled so as not to exceed an overtravel value of the contacts.

Certainly, in other embodiments, the plane where the normally open movable contact 2211 and the normally closed movable contact 2212 of the movable contact body 221 are located is coplanar with the pole surface of the armature 21, so that the stress generated when the armature 21 contacts the iron core 32 of the base part 3 and the stress generated when the movable and static contacts contact each other basically reach a stable state at the same time, thereby reducing the lateral torque of the movable contact piece 22 and further improving the stability of the swinging action of the movable part 2.

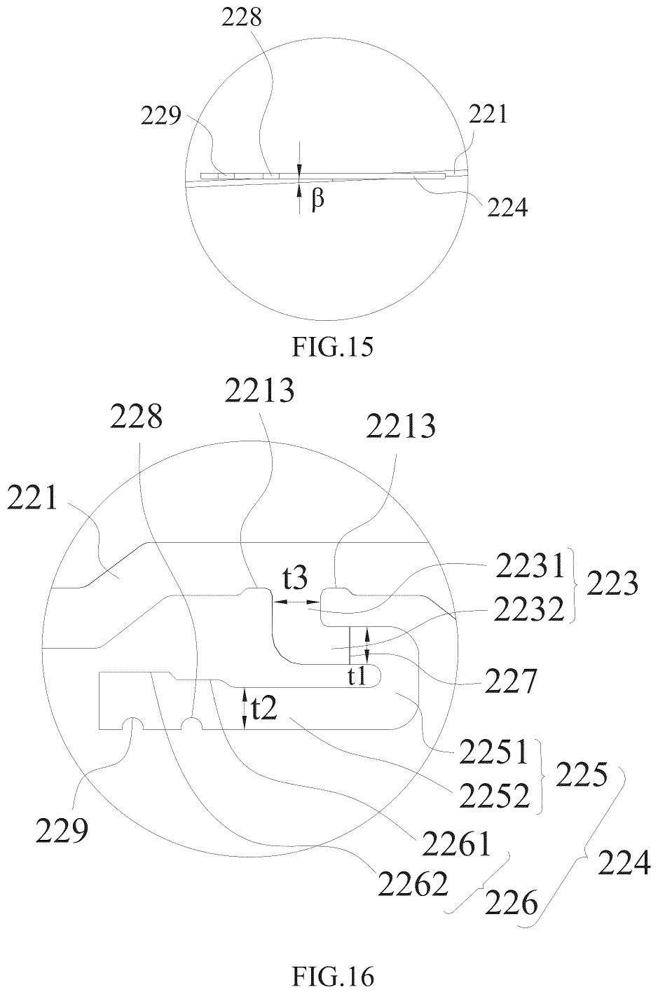

As shown in FIG. 16, FIG. 16 shows a partial enlarged view of X2 in FIG. 14B. A side of the movable contact body 221 facing the soldering lug structure 222 is also provided with a recess 2213, and the recess 2213 is disposed at an edge of the connection between the connecting portion 223 and the movable contact body 221.

As an example, along the length direction D1 of the armature 21, each of both opposite sides of the connecting portion 223 is provided with the recess 2213. In this way, the length of the connecting portion 223 may be increased without increasing an overall width of the relay.

Further, a chamfer may be provided at each corner of the recess 2213, which may reduce stress concentration through chamfer transition. As an example, the chamfer may be in a circular arc shape, but is not limited thereto.

Still referring to FIG. 16, along the length direction D1 of the armature 21, the first soldering structure 228 is closer to the connecting portion 223 relative to the second soldering structure 229. The soldering portion 224 includes a body portion 225 and a widened part 226. The body portion 225 is connected to the movable contact body 221 through the connecting portion 223. The first soldering structure 228 and the second soldering structure 229 are on the body portion 225. The fold line 227 is provided at the connection between the body portion 225 and the connecting portion 223. The widened part 226 is connected to the body portion 225, and along the width direction D2 of the armature 21, the widened part 226 corresponds to the position of the first soldering structure 228 and/or the second soldering structure 229.

By providing the widened part 226, the rigidity at the solder joint position is improved to prevent stress from being transferred to the first soldering structure 228 when the movable part 2 swings.

Further, the widened part 226 is provided on a side of the body portion 225 facing the movable contact body 221, and the widened part 226 corresponds to the position of the first soldering structure 228 and/or the second soldering structure 229.

As an example, the widened part 226 includes a first widened section 2261 and a second widened section 2262. The first widened section 2261 corresponds to the position of the first soldering structure 228, and the second widened section 2262 corresponds to the position of the second soldering structure 229. Along the width direction D2 of the armature 21, the size of the first widened section 2261 is smaller than the size of the second widened section 2262.

The first widened section 2261 completely covers the position of the first soldering structure 228 in the length direction D1 of the armature 21, and the second widened section 2262 completely covers the position of the second soldering structure 229 in the length direction D1 of the armature 21.

Along the length direction D1 of the armature 21, a start point of the first widened section 2261 is closer to the connecting portion 223 relative to the first soldering structure 228. A start point of the second widened section 2262 is located between the first soldering structure 228 and the second soldering structure 229.

By providing the first widened section 2261 and the second widened section 2262 with different widths at the positions corresponding to the first soldering structure 228 and the second soldering structure 229 in the soldering portion 224, it is ensured that the attraction force stably matches the reaction force. As a result, when a solder joint formed by the first soldering structure 228 is disengaged during operation, the matching between the attraction force and the reaction force of a solder joint formed by the second soldering structure 229 remains basically unchanged during operation, ensuring the stability of the operating voltage and the release voltage of the relay, avoiding permanent failure of the relay after one solder joint fails, and improving the service life and reliability of the product.

Specifically, as shown in FIGS. 14A, 14B, and 24, FIG. 24 shows a schematic view of a magnitude of a reaction force generated by deformation of the soldering lug structure according to embodiments of the present disclosure. The reaction force F generated by the soldering lug structure 222 is F=a(W*E*D*T³)/L³.

In the equation, a is a constant, and D represents a displacement (mm) of the soldering lug structure 222 and is related to the structure of the product and is constrained by the stroke of the armature 21 rotating around the fulcrum. E represents a material elasticity coefficient (Gpa) of the soldering lug structure 222, and E is a constant. T represents a thickness (mm) of the soldering lug structure 222, and the material elasticity coefficient E and the thickness T of the soldering lug structure are both material-related. W represents a width (mm) of the solder joint position along the width direction D2 in the soldering lug structure 222 (i.e., the width at the position of the first soldering structure 228/the second soldering structure 229 in the soldering lug structure 222). L represents a length from the solder joint to the fold line 227 along the length direction D1.

Accordingly, it may be seen that after the relay product structure is finalized and the material for the soldering lug structure 222 is selected, the magnitude of F during use of the relay is mainly related to a ratio of W/L3. Thus, in order to ensure that the magnitude of F remains stable before and after the first soldering structure 228 is disengaged, it is necessary to ensure that the ratio of W/L3 is stable.

Therefore, in this embodiment, as shown in FIGS. 14A and 14B, in the soldering lug structure 222, a width at the position where the first soldering structure 228 is located is W1, and a width at the position where the second soldering structure 229 is located is W2. A length from the first soldering structure 228 to the fold line 227 is L1, and a length from the second soldering structure 229 to the fold line 227 is L2. By optimizing the dimensions, (W1/L13)≈(W2/L23) is ensured, i.e., the stability of the reaction force F may be guaranteed when the first soldering structure 228 is in operation and when the first soldering structure 228 is disengaged and the second soldering structure 229 is in operation, thereby ensuring that the matching between the attraction force and the reaction force of the relay remains basically unchanged, and ensuring the stability of the operating voltage and the release voltage of the relay.

In addition, a maximum stress when the soldering lug structure 222 undergoes deformation is σ=b*L/W*T2, in which b is a constant.

Still referring to FIG. 16, the first soldering structure 228 and the second soldering structure 229 are at the side of the soldering portion 224 facing away from the movable contact body 221, and the widened part 226 is at a side of the soldering portion 224 facing the movable contact body 221.

The connecting portion 223 includes a first connecting section 2231 and a second connecting section 2232 that are perpendicular to each other. One end of the first connecting section 2231 is connected to the movable contact body 221, one end of the second connecting section 2232 is connected to the other end of the first connecting section 2231, and the other end of the second connecting section 2232 is connected to the body portion 225.

A circular arc transition or a rounded transition is provided at the connection between the first connecting section 2231 and the movable contact body 221 as well as the connection between the first connecting section 2231 and the second connecting section 2232 to reduce stress concentration.

The first connecting section 2231 extends perpendicularly to the length direction D1 of the armature 21, the second connecting section 2232 extends parallel to the length direction D1 of the armature 21, and the second connecting section 2232 extends from the first connecting section 2231 to one movable contact of the movable contact body 221.

The body portion 225 is J-shaped and includes a bent section 2251 and an extension section 2252. One end of the bent section 2251 is connected to the other end of the second connecting section 2232, and the extension section 2252 is connected to the other end of the bent section 2251. The first soldering structure 228 and the second soldering structure 229 are in the extension section 2252. The bent section 2251 turns 180 degrees to allow the extension section 2252 to extend from the bent section 2251 to another movable contact of the movable contact body 221. The fold line 227 is provided at the connection between the bent section 2251 and the second connecting section 2232.

As shown in FIGS. 14A, 14B, and 16, a width t1 of a portion of the bent section 2251 connected to the connecting portion 223 is less than or equal to a width t2 of a portion of the extension section 2252 provided with the first soldering structure 228 and the second soldering structure 229, that is, t1≤t2. Meanwhile, a width t3 of the first connecting section 2231 is greater than the width t1 of the bent section 2251 and is greater than the width t2 of the portion of the extension section 2252 where the first soldering structure 228 and the second soldering structure 229 are provided, that is, t3>t1, and t3>t2. Through this design, the rigidity of the armature component is effectively increased. When the armature swings, the deformation of the movable contact piece 22 is formed in the bent section 2251, which improves the stability of product parameters.

The first soldering structure 228 and the second soldering structure 229 are at a side of the extension section 2252 facing away from the movable contact body 221, and the first widened section 2261 and the second widened section 2262 are at a side of the extension section 2252 facing the movable contact body 221.

As an example, in the soldering lug structure 222, a width of a portion where the fold line 227 is located is less than or equal to a width at positions where the first soldering structure 228 and the second soldering structure 229 are located.

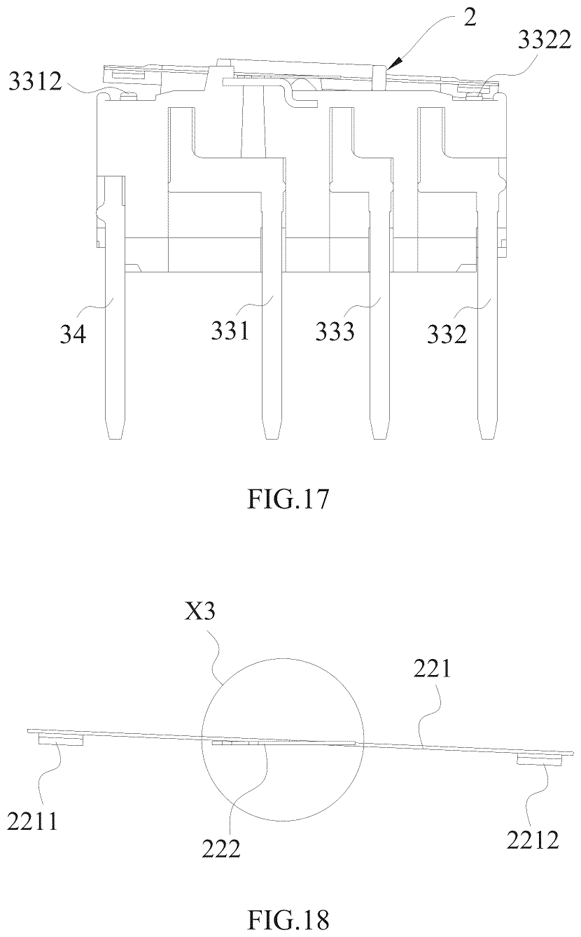

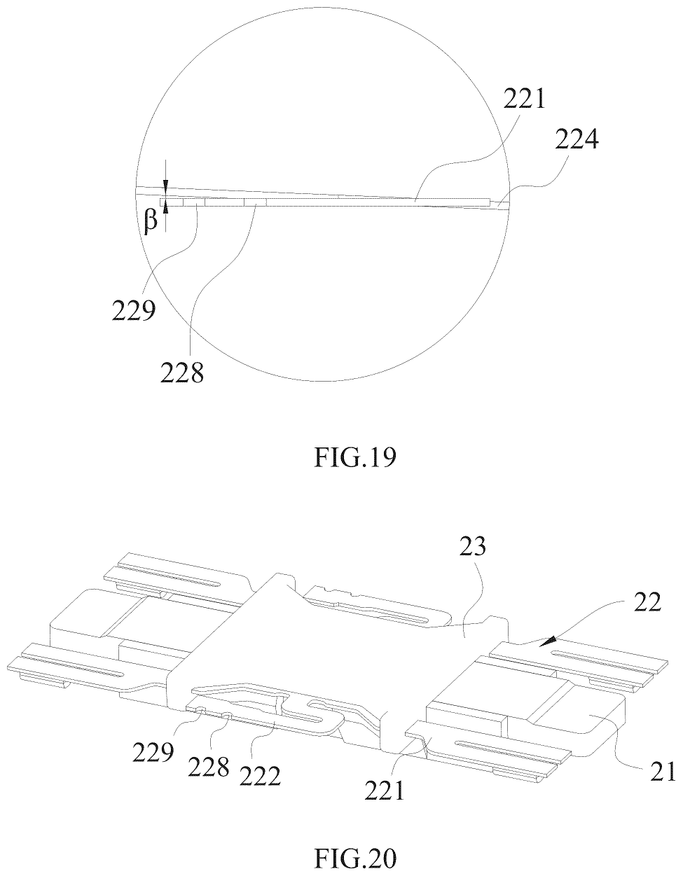

As shown in FIGS. 17-19, FIG. 17 shows a schematic side view of a relay according to a second embodiment of the present disclosure with a housing 1 removed; FIG. 18 shows a schematic side view of a movable contact piece 22 in FIG. 17; FIG. 19 shows an enlarged partial view of X3 in FIG. 18. Similarities between the second embodiment and the first embodiment will not be repeated, but differences are as follows.

A portion of the soldering portion 224 provided with the first soldering structure 228 and the second soldering structure 229 is bent towards a direction close to the base part 3 relative to the movable contact body 221. That is, the soldering portion 224 is bent downwards relative to the movable contact body 221 and the connecting portion 223 through the fold line 227.

As shown in FIG. 17 and FIG. 18, an angle β is formed between the soldering portion 224 and the movable contact body 221. When the first soldering structure 228 and the second soldering structure 229 of the soldering portion 224 are horizontally soldered on the soldering table 3332, the movable contact body 221 is higher on the left and lower on the right. Therefore, when the portion of the soldering portion 224 provided with the first soldering structure 228 and the second soldering structure 229 is bent towards the direction close to the base part 3 relative to the movable contact body 221, the armature 21 at a side close to the coil terminal 34 contacts a pole surface of the iron core 32, forming a normally open end; the armature 21 at a side away from the coil terminal 34 separates from the pole surface of the iron core 32, forming a normally closed end.

Accordingly, it may be seen that by providing the fold line 227, the soldering portion 224 may be folded up or down as needed, which facilitates adaptive adjustment of the normally open end and the normally closed end of the relay according to usage requirements.

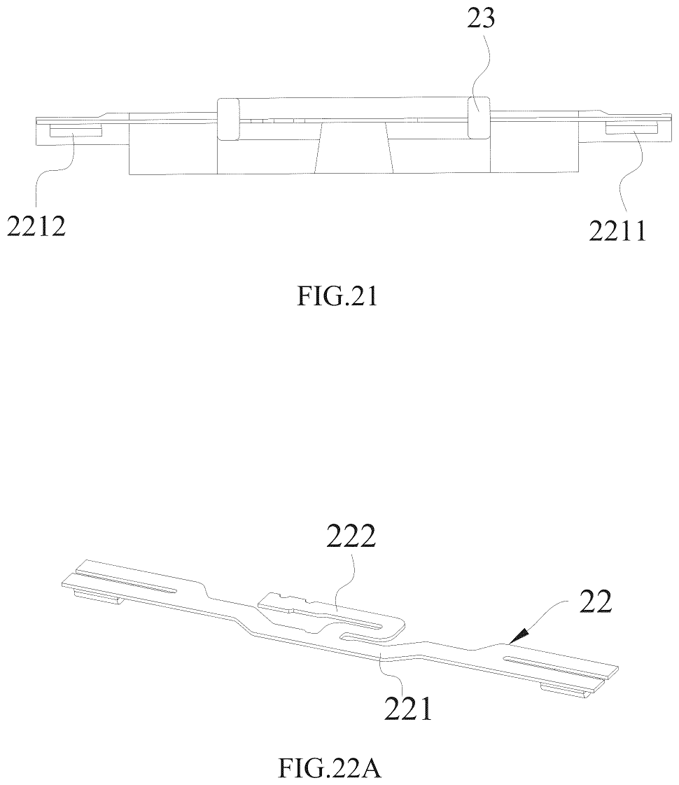

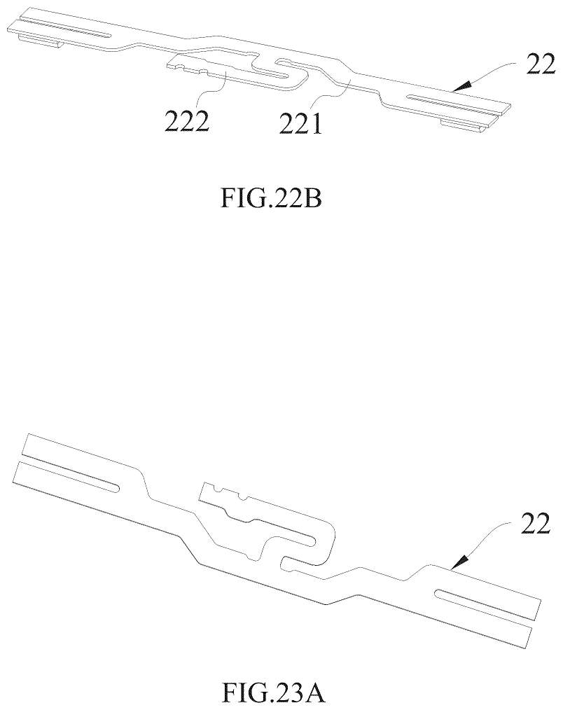

As shown in FIG. 20 to FIG. 22B, FIGS. 20 and 21 show schematic views of a movable part 2 of a relay according to a third embodiment of the present disclosure from two different angles of view. FIG. 22A shows a schematic perspective view of one movable contact piece of the relay according to the third embodiment of the present disclosure; and FIG. 22B shows a schematic perspective view of another movable contact piece of the relay according to the third embodiment of the present disclosure. Similarities between the third embodiment and the first and second embodiments will not be repeated, but differences are as follows.

In the soldering lug structure 222, there is no fold line 227, and the soldering portion 224, the connecting portion 223, and the movable contact body 221 are coplanar.

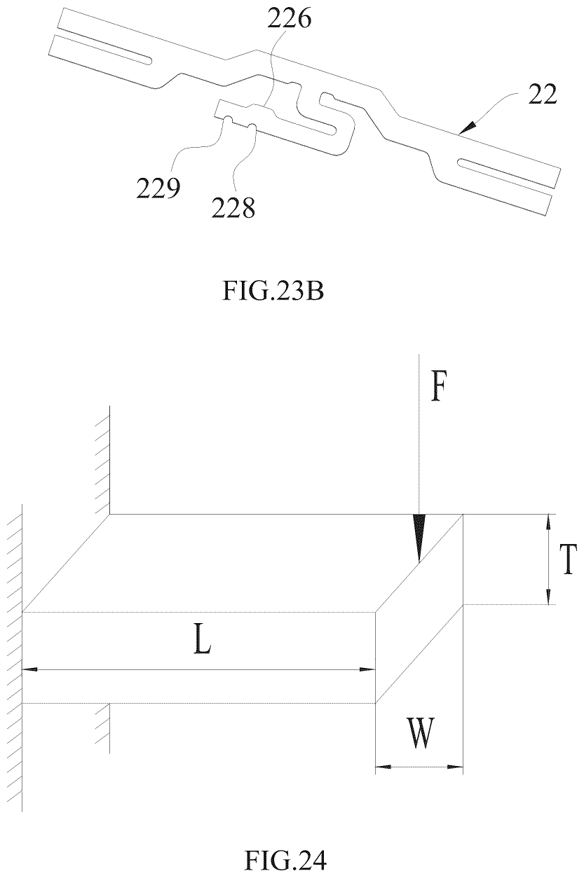

As shown in FIG. 23A and FIG. 23B, FIG. 23A shows a schematic view of one movable contact piece of a relay according to a fourth embodiment of the present disclosure; and FIG. 23B shows a schematic view of another movable contact piece of the relay according to the fourth embodiment of the present disclosure. Similarities between the fourth embodiment and the above embodiments will not be repeated, but differences are as follows.

When the parameter variation of the product is insensitive or the parameter margin is large, the widened section 226 is only arranged corresponding to the first soldering structure 228, while the widened section 226 is not provided corresponding to the second soldering structure 229.

For the relay according to embodiments of the present disclosure, the movable contact piece and the base part are connected through the first soldering structure and the second soldering structure; at least two soldering structures may better ensure the strength of connection between the movable contact piece and the base part making it difficult for the soldering lug structure to disengage from the base part and improving the mechanical life of the relay. Meanwhile, the movable contact piece and the base part are connected through the first soldering structure and the second soldering structure, which may better ensure conductivity and heat dissipation, thereby reducing a temperature rise at a solder joint position.

It can be understood that the various embodiments/implementations provided in this disclosure may be combined with each other without contradiction, which will not be elaborated herein.

In embodiments of the present disclosure, the terms “first”, “second”, and “third” are used for a descriptive purpose only and should not be understood as indicating or implying relative importance; the term “a plurality of” refers to two or more, unless otherwise specified. The terms “mounted,” “connected,” “coupled,” “fixed” and the like are used broadly; for example, “connected” may be fixed connections, detachable connections, or integral connections; “coupled” may be direct connections or indirect connections via intervening structures. The specific meanings of the above terms in embodiments of the present disclosure may be understood by those skilled in the art according to specific situations.

In the description of embodiments of the present disclosure, it should be understood that the terms “up”, “down”, “left”, “right”, “front”, “rear” and the like indicate orientations or positions as then described or as shown in the drawings under discussion, and are only for convenience and simplification of the description of embodiments of the present disclosure, rather than indicate or imply that the device or unit referred to must have a particular orientation or be constructed and operated in a particular orientation. Thus, these terms shall not be construed as limitation on the present disclosure.

Reference throughout this specification to “an embodiment,” “some embodiments,” “a specific embodiment” or the like means that a particular feature, structure, material, or characteristic described in connection with the embodiment or example is included in at least one embodiment or example of the present disclosure. Thus, the appearances of the above phrases throughout this specification are not necessarily referring to the same embodiment or example of the present disclosure. Furthermore, the particular features, structures, materials, or characteristics may be combined in any suitable manner in one or more embodiments or examples.

The above are only preferred embodiments of the present disclosure and are not intended to limit the present disclosure. For those skilled in the art, the embodiments of the present disclosure may have various modifications and variations. Any modifications, equivalent substitutions, improvements or the like made within the spirit and principles of embodiments of the present disclosure shall be included within the protection scope of embodiments of the present disclosure.

What is claimed is:

1. A relay, comprising a base part and a movable part that is swingable relative to the base part, the movable part comprising a movable contact piece, an armature, and a first plastic body, the movable contact piece and the armature being assembled into an integral piece through the first plastic body, and the movable contact piece comprising:
a movable contact body; and
a soldering lug structure, comprising a connecting portion and a soldering portion, wherein the soldering portion is connected to the movable contact body through the connecting portion; the soldering portion comprises a first soldering structure and a second soldering structure that are both soldered to the base part; and the first soldering structure and the second soldering structure are at a same side of the connecting portion in a length direction of the armature.

2. The relay according to claim 1, wherein the soldering portion is not coplanar with the movable contact body.

3. The relay according to claim 2, wherein the connecting portion is coplanar with the movable contact body;
a fold line is provided at a connection between the connecting portion and the soldering portion, and the soldering portion is bent relative to the connecting portion at the fold line.

4. The relay according to claim 3, wherein a portion of the soldering portion provided with the first soldering structure and the second soldering structure is bent relative to the movable contact body towards a direction away from the base part; or
a portion of the soldering portion provided with the first soldering structure and the second soldering structure is bent relative to the movable contact body towards a direction close to the base part.

5. The relay according to claim 3, wherein an extension direction of the fold line is perpendicular to the length direction of the armature.

6. The relay according to claim 3, wherein along the length direction of the armature, the fold line is at another side of the connecting portion relative to the first soldering structure and the second soldering structure.

7. The relay according to claim 3, wherein two ends of the movable contact body in the length direction of the armature are provided with a normally open movable contact and a normally closed movable contact, respectively; and a connection line between the normally open movable contact and the normally closed movable contact passes through a midpoint of the fold line.

8. The relay according to claim 1, wherein the soldering portion comprises:
a body portion connected to the movable contact body through the connecting portion, the first soldering structure and the second soldering structure being on the body portion; and
a widened part connected to the body portion and corresponding to a position of the first soldering structure and/or the second soldering structure along a width direction of the armature.

9. The relay according to claim 8, wherein along the length direction of the armature, the first soldering structure is closer to the connecting portion relative to the second soldering structure;
the widened part comprises a first widened section and a second widened section, the first widened section corresponding to a position of the first soldering structure, and the second widened section corresponding to a position of the second soldering structure;
along the width direction of the armature, a size of the first widened section is smaller than a size of the second widened section.

10. The relay according to claim 8, wherein along the length direction of the armature, the first soldering structure is closer to the connecting portion relative to the second soldering structure;
the widened part comprises a first widened section and a second widened section, the first widened section corresponding to a position of the first soldering structure, and the second widened section corresponding to a position of the second soldering structure;
the first widened section completely covers a position of the first soldering structure in the length direction of the armature, and the second widened section completely covers a position of the second soldering structure in the length direction of the armature.

11. The relay according to claim 10, wherein along the length direction of the armature, a start point of the first widened section is closer to the connecting portion relative to the first soldering structure.

12. The relay according to claim 8, wherein the first soldering structure and the second soldering structure are at a side of the soldering portion facing away from the movable contact body, and the widened part is at a side of the soldering portion facing the movable contact body.

13. The relay according to claim 1, wherein two ends of the movable contact body in the length direction of the armature are provided with a normally open movable contact and a normally closed movable contact, respectively; and a plane where the normally open movable contact and the normally closed movable contact are located is coplanar with a pole surface of the armature or is higher than the pole surface of the armature.

14. The relay according to claim 1, wherein a side of the movable contact body facing the soldering lug structure is provided with a recess, and the recess is disposed at an edge of a connection between the connecting portion and the movable contact body.

15. The relay according to claim 1, wherein the soldering portion is coplanar with the movable contact body.

16. The relay according to claim 1, wherein the soldering portion comprises:
a bent section, one end of the bent section being connected to the connecting portion; and
an extension section, one end of the extension section being connected to another end of the bent section, and the first soldering structure and the second soldering structure being in the extension section,
wherein a width of a portion of the bent section connected to the connecting portion is less than or equal to a width of a portion of the extension section provided with the first soldering structure and the second soldering structure.

17. The relay according to claim 16, wherein the connecting portion comprises:
a first connecting section, one end of the first connecting section being connected to the movable contact body, wherein a width of the first connecting section is greater than a width of the bent section and is greater than the width of the portion of the extension section provided with the first soldering structure and the second soldering structure; and
a second connecting section, one end of the second connecting section being connected to another end of the first connecting section, and another end of the second connecting section being connected to the bent section, wherein the first connecting section is perpendicular to the second connecting section.
